(19) United States
(12) Patent Application Publication
(10) Pub. No.: US 2024/0347980 A1
(43) Pub. Date: Oct. 17, 2024

(54) Shield Plate Mounting

(71) Applicant: ERNI International AG, Schaffhausen (CH)

(72) Inventors: Cornelius Thomas, Bad Boll (DE); Heiko Schutze, Schorndorf (DE); Oguzhan Avkiran, Lorch (DE); Dominik Jonas, Plunderhausen (DE)

(73) Assignee: ERNI International AG, Schaffhausen (CH)

(21) Appl. No.: 18/749,986

(22) Filed: Jun. 21, 2024

Related U.S. Application Data
(63) Continuation of application No. PCT/EP2022/085095, filed on Dec. 9, 2022.

(30) Foreign Application Priority Data
Dec. 22, 2021 (DE) 10 2021 134 273.2

(51) Int. Cl. H01R 13/6581; H01R 13/6594

(52) U.S. Cl. CPC H01R 13/6581; H01R 13/6594

(57) ABSTRACT

A plug connector includes a base body and a shielding element. The base body has a fastening extension projecting from an arrangement surface. The arrangement surface is positioned in an arrangement pocket of the base body. The fastening extension does not protrude from the arrangement pocket. The shielding element has an extension receptacle fastening the shielding element to the fastening extension. The shielding element is formed of a metallic material. The extension receptacle has a receiving contour directed inwardly into the extension receptacle and a clamping portion that rests on a fastening surface of the fastening extension in a form-fitting and/or force-fitting manner when the shielding element is fastened to the fastening extension.

### CROSS-REFERENCE TO RELATED APPLICATIONS

This application is a continuation of PCT International Application No. PCT/EP2022/085095, filed on Dec. 9, 2022, which claims priority under 35 U.S.C. § 119 to German Patent Application No. 102021134273.2, filed on Dec. 22, 2021.

### FIELD OF THE INVENTION

The present invention relates to a plug connector and a method for fastening a shielding element of a plug connector.

### BACKGROUND OF THE INVENTION

Plug connectors are provided for electrical and mechanical connection with mating plug connectors, wherein electrical components such as circuit boards or cables are attached to the plug connectors or mating plug connectors. The plug connectors and/or the mating plug connectors are provided with shielding plates for electrical shielding.

A plug connector is known from DE 10 2018 127 814 A1, which has shielding on both sides by means of two shielding plates. The single shielding plate has latching hooks that engage in a form-fitting manner in molded elements of the housing of the plug connector.

U.S. Pat. Nos. 5,219,294 A and 5,567,168 A, which are similar in content, each relate to a male and a female plug connector. The male plug connector housing (see FIG. 14 and following) has through-channels for electrical contact elements on the rear side (see FIG. 23). The plug connector has widened channels with shoulders and a platform as well as a rectangular hole section (see FIG. 16a). The female plug connector, too, has a similar structure, in which the electrical contact elements are guided through the plastic housing from the rear side of the plug connector (see FIG. 13).

DE 10 2005 059 990 A1 discloses a plug connector. A shielding plate—mounted from the direction of the connector face—is fastened by means of latching connections in the form of latching hooks, which can be engaged in depressions on the female multipoint connector (FIG. 4) or male multipoint connector (FIG. 2). The shielding plate can be latched to the housing at several engagement levels, see FIG. 2.

In US 2014/0170895 A1, a surface mount termination (SMT) connector for cables with lateral openings, each in the form of a keyhole, is disclosed. As the term suggests, the SMT connector is applied to a printed circuit board and holds a cable there, which is inserted into the keyhole geometry (FIG. 6), displaced laterally, and clamped in place. This cuts the insulation sheath of the outer conductor (FIGS. 7, 8). This can be understood as contacting via a cut-clamp connection.

Furthermore, DE 10 2018 222 266 A1 describes that a shielding plate is attached to a housing by means of specially shaped attachment pieces. The detailed FIGS. 8 and 9 are geometrically reminiscent of the blade of a spade-shaped trowel. The attachment pieces have plate-shaped geometries with latching lugs and a stepped latching plane or sheet metal connection. The attachment pieces are attached in attachment grooves on the female multipoint connector (see FIG. 7, sheet metal top and bottom front edge) and/or the male multipoint connector (see FIG. 4, sheet metal top front edge).

U.S. Pat. No. 6,042,398 A discloses an electrical plug connector comprising an insulating housing having a connection surface, a plate mounting surface, two opposing sides, two opposing ends, and a plurality of slots formed on each side; a pair of brackets each attached to one of the two ends of the insulating housing, wherein the bracket has a pair of arms each extending over a section of one side of the insulating housing; a pair of grounding plates each fastened to one side of the insulating housing and overlapping and engaging the arms of the brackets on the one side of the insulating housing, wherein the grounding plate has a plurality of hooks each received in one of the plurality of slots of the insulating housing; and a plurality of contacts received in the insulating housing, wherein each contact has a solder tab extending outwardly from the plate mounting surface over the sides of the insulating housing, wherein a corresponding number of contacts are aligned with and contact the plurality of hooks of the grounding plate.

U.S. Pat. No. 5,470,238 A discloses a shielded electrical ribbon cable connector assembly having an overmolded ribbon cable connector and a method of manufacturing the connector using overmolding.

U.S. Pat. No. 6,551,139 B1 discloses an electrical connector comprising a housing and a pair of shielding plates arranged on opposite sides of the housing. The housing has opposing sidewalls, a slot between the sidewalls, and a plurality of connection passages communicating with the slot. Each side wall has a plurality of holders for attaching the shielding plate. Each plate has a plurality of earthing connections received at the connection passages of the housing to be electrically connected to a complementary connector. A plurality of soldering threads extend from each of the shielding plates opposite the earthing connections to be soldered to a printed circuit board and securely electrically connected thereto.

An electrical connector having an insulating body, a plurality of connection elements, a pair of first earthing elements and a second earthing element can be derived from CN 201038381 Y. The electrical connector is earthed with a printed circuit board. The earthing elements are connected to the insulating body via latching connections.

### SUMMARY OF THE INVENTION

A plug connector includes a base body and a shielding element. The base body has a fastening extension projecting from an arrangement surface. The arrangement surface is positioned in an arrangement pocket of the base body. The fastening extension does not protrude from the arrangement pocket. The shielding element has an extension receptacle fastening the shielding element to the fastening extension. The shielding element is formed of a metallic material. The extension receptacle has a receiving contour directed inwardly into the extension receptacle and a clamping portion that rests on a fastening surface of the fastening extension in a form-fitting and/or force-fitting manner when the shielding element is fastened to the fastening extension.

### BRIEF DESCRIPTION OF THE DRAWINGS

Details, features and advantages of the invention are the subject of the following description and the drawing of an embodiment.

FIG. 1 is an isometric view of a shielding element fastened in a form-fitting and/or force-fitting manner to a base body of a plug connector;

FIG. 2 is an isometric view of a base body with an arrangement pocket with a fastening extension for form-fitting and/or force-fitting fastening;

FIG. 3 is an isometric view of a tab of the shielding element, which is used for form-fitting and/or force-fitting fastening;

FIG. 4 is an isometric view of a punched extension receptacle in a shielding plate tab, which still needs to be offset to achieve its final shape;

FIG. 5 is an isometric view of a first method step for manufacturing the form-fitting and/or force-fitting fastening, wherein the shielding element is abutted laterally against the base body;

FIG. 6 is an isometric view of a second method step for manufacturing the form-fitting and/or force-fitting fastening, wherein the fastening extension is guided into an extension receptacle of the shielding element;

FIG. 7 is an isometric view of a third method step for producing the form-fitting and/or force-fitting fastening, wherein the fastening extension is clamped in a clamping portion of the extension receptacle;

FIG. 8 is an isometric view of a fastening state of the shielding plate after clamping or latching the extension receptacle on the fastening extension of the housing (shown semi-transparent); and

FIG. 9 is an isometric view of the shielding element attached in a form-fitting and/or force-fitting manner to a base body of a plug connector.

### DETAILED DESCRIPTION

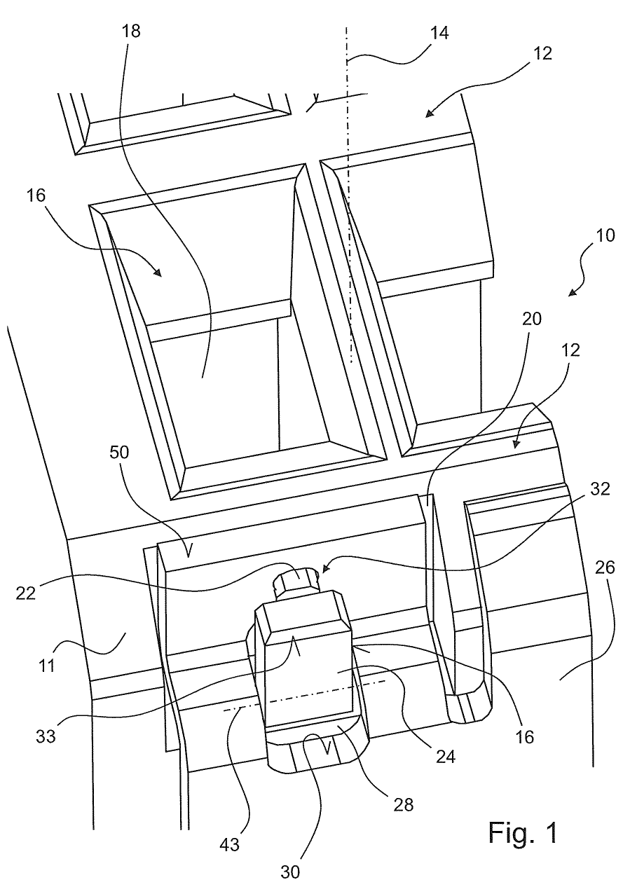

An embodiment according to the invention is shown in FIG. 1. A plug connector 10 with a base body 11 is shown there, which has a mechanical contacting region 12 on the upper side of the base body 11, which is also referred to as the connector face. The alignment of the upper side is to be understood in the reading direction of the drawing. The contacting region 12 is provided for electrical and mechanical connection to a mating plug connector. The electrical connection of the plug connector 10 to the mating plug connector is created by moving the electrical contact elements within the housing 10 along a connection axis 14, which is aligned perpendicularly to the contacting region.

The contacting region 12 of the plug connector 10 arranged inside the plug connector 10—also known as the connector face—is either configured with male contact elements—known as blades—thus referring to the plug multipoint connector as a male connector. Alternatively, the contacting region can be configured with female contact elements—known as springs—thus referring to it as a female multipoint connector.

According to the exemplary FIG. 1, the plug connector 10 is a female plug connector with contact chambers formed in the base body, which are provided to receive female contact elements. The mating plug connector is configured as a male mating plug connector, which has male contact elements. The mating plug connector can be mechanically and electrically connected to the female plug connector 10. The contacting region 12 of the plug connector 10 has funnel-shaped channels towards the connector face, which lead to the contact chambers. The post-shaped male contact elements are guided into the channels to connect the plug connector with the mating plug connector in order to be guided by the plugging movement along the connection axis up to the female contact elements to establish an electrical connection. The contacting region 12 of the female plug connector 10 is a partial area of the entire female plug connector assembly, the so-called female multipoint connector. The male mating plug connector assembly that mechanically and electrically matches the plug connector 10 is called the male multipoint connector.

As shown in FIG. 1, interface openings 18 of the contacting region 12 extend along an imaginary interface plane, which is aligned perpendicularly to the connection axis 14 and is arranged flat on the upper side of the base body 11. Here, purely by way of example, several rows of interface openings 18 arranged next to one another are arranged on the contacting region 12.

As shown in FIG. 1, the base body 11 has an arrangement surface 20 aligned perpendicularly to the imaginary interface plane and parallel to the connection axis 14. The arrangement surface 20 is arranged next to the contacting region 12. Several arrangement surfaces 20 can also be realized on the base body 11, in particular on different sides of the base body 11. In an alternative embodiment, the arrangement surface 20 can also be tilted relative to the connection axis 14. One or more arrangement surfaces 20 can be formed in the same way on the mating plug connector.

A projecting fastening extension 22 is arranged on the arrangement surface 20, which is formed in one piece from the same material as the base body 11. The fastening extension 22 has a securing portion 24 at its end distal from the arrangement surface 20, as shown in FIG. 1. The fastening extension 22 is used for form-fitting and/or force-fitting fastening of a metallic shielding element 26, for example for shielding the plug connector 10 against electromagnetic influences. The shielding element 26 is arranged laterally on the base body 11 next to the contacting region 12, so that lateral shielding of the plug connector 10 is achieved. The shielding element abuts flatly against the arrangement surface 20 in sections. Furthermore, the mating plug connector can also have the shielding element 26, which is attached to the base body of the mating plug connector in the same way.

The shielding element 26, as shown in FIG. 1, has an extension receptacle 28 for the form-fitting and/or force-fitting fastening of the shielding element 26 to the fastening extension 22. The extension receptacle 28, in the shown embodiment, has a keyhole-shaped receiving contour 30 directed inwardly into the extension receptacle 28. In particular, the shielding element 26 has a plurality of extension receptacles 28, which can be connected to a complementary number of fastening extensions 22. The exemplary shielding element 26 consists of a sheet metal which is produced in a punching and bending process. The shielding element 26 can be made of a sheet metal or equivalent flat, electrically conductive structures.

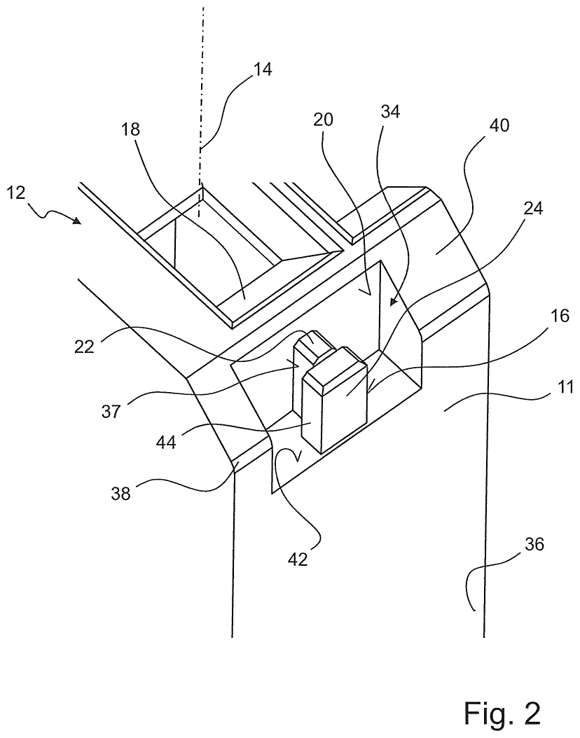

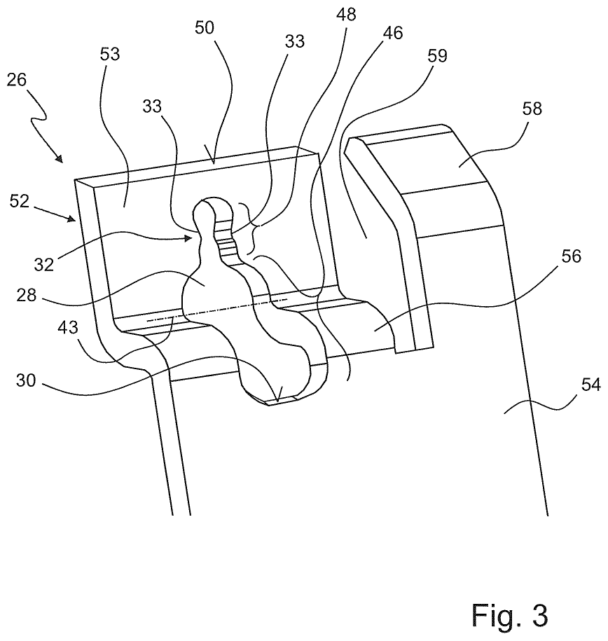

The extension receptacle 28 has a clamping portion 32 which has at least one protrusion 33, as shown in FIG. 3. By way of example only, FIG. 1 shows a clamping portion 32 with two protrusions 33 on the receiving contour 30. In the force-fitting fastening state, the protrusions 33 of the clamping portion 32 rest on a fastening surface 37 arranged on the outside of the fastening extension 22, as shown in FIG. 2.

The shielding plate 26 can be easily and securely mounted to the fastening extension 22 on the housing 10 by the extension receptacle 28. In particular, the fastening extension 22 extends essentially perpendicularly from the arrangement surface 20, wherein the fastening extension 22 can be configured in a ribbed or solitary manner.

A simple and low-wear molding tool can be used to form the fastening extension 22, in an embodiment in one piece with the base body 11. For cost reasons, it is of great interest in manufacturing to use robust molding tools when using an injection molding process to manufacture such a base body 11. The same applies to the shielding element 26, which has the extension receptacle 28 that can be easily connected to the fastening extension 22. The extension receptacle 28 can be manufactured in just a few quick manufacturing steps.

In FIG. 2, the base body 11 is shown without shielding element 26. The base body 11 has a side surface 36 formed on its side, on which the shielding element 26 is arranged. The side surface 36 is aligned essentially parallel to the connection axis of the plug connector and the mating plug connector 14 and perpendicularly to the interface plane. A chamfer 40 can be formed on the base body 11 between the interface plane and a surface edge 38 of the side surface 36.

The arrangement surface 20 is positioned in an arrangement pocket 34, wherein the fastening extension 22 does not protrude out of the arrangement pocket 34 beyond the side surface 36. The arrangement pocket 34 extends from the exemplary side surface 36, which is aligned parallel to the arrangement surface 20, into the base body 11. In this case, the arrangement pocket 34 is open both on the side surface 36 and on a side facing the interface plane. In the shown embodiment, the arrangement pocket 34 is open at the chamfer 40.

The fastening extension 22 and the securing portion 24 do not protrude beyond the side surface 36 and the plane of the contacting region 12. The fastening extension 22 projects perpendicularly from the arrangement surface 20, wherein the securing portion 24 is arranged between the distal end of the fastening extension 22 and the side surface 36. Furthermore, the fastening extension 22 and the securing portion 24 extend from a further pocket wall 42 in the direction of the chamfer 40, wherein the pocket wall 42 is aligned perpendicularly to the arrangement surface 20.

The fastening extension 22 arranged centrally in the arrangement pocket 34 has a mushroom-shaped cross-section parallel to the interface plane together with the securing portion 24 arranged at its distal end with respect to the arrangement surface 20. As shown in FIG. 2, the securing portion 24 is wider than the fastening extension 22 with respect to a transverse axis aligned parallel to the arrangement surface 20, wherein the distal end of the attachment section 22 is attached centrally on a side of the securing portion 24 facing the arrangement surface 20. The securing portion 24 has a securing outer edge 16, which is offset from the fastening surface 37 due to the greater width of the securing portion 24. This prevents the shielding element 26 from being removed in a direction perpendicular to the arrangement surface 20 of the base body 11 when the clamping portion 32 in the shielding element 26 is arranged on the fastening surface 37. The securing portion 24 is approximately cuboid in shape, wherein the fastening extension 22 can project slightly beyond the securing portion 24 in the direction of the interface 12.

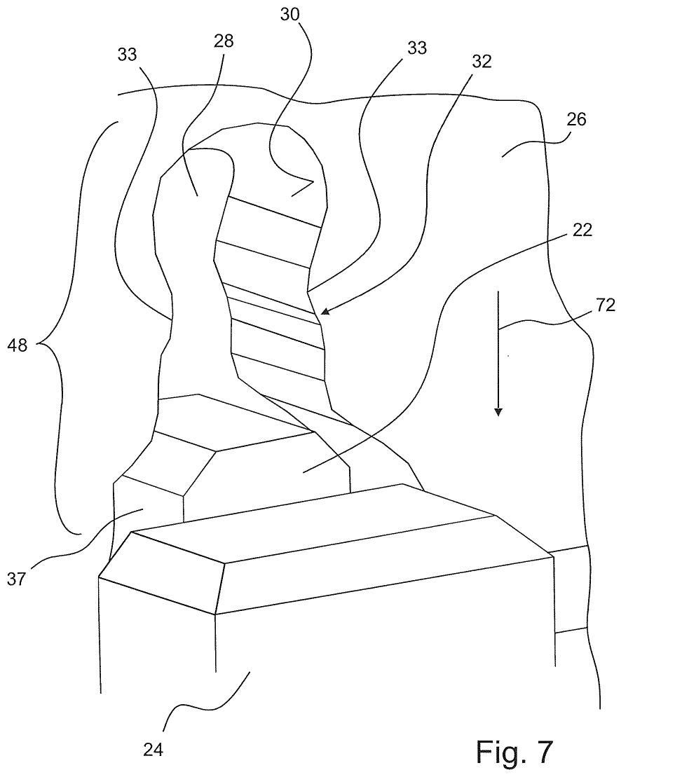

The shielding element 26 is shown in FIG. 3, wherein the extension receptacle 28 is formed completely within the shielding element 26 such that the receiving contour 30 surrounds the extension receptacle 28 in a closed manner. The extension receptacle 28 is divided into a first receiving section 46 and a second receiving section 48. The first receiving section 46 is wider than the second receiving section 48 with respect to the transverse axis 43. The first receiving section 46 has a width which is sufficient to guide the securing portion 24 through the first receiving section 46. The second receiving section 48, on the other hand, has a width with respect to the transverse axis 43, which is adapted to the width of the fastening extension 22, such that the fastening extension 22 can be inserted into the clamping portion 32 in the second receiving section 48 in a clamping manner by a clamping movement 72 (see FIG. 7) of the shielding element 26 relative to the base body 11. For this purpose, the opposing protrusions 33 in the second receiving section 48 are formed on the receiving contour 30. The protrusions 33 are directed inwardly into the extension receptacle 28 and aligned parallel to the arrangement surface 20. During force-fit fastening, the fastening extension 22 is clamped or latched between the protrusions 33.

The clamping movement of the shielding plate 26 can be aligned parallel to the arrangement surface 20 and run along the arrangement surface 20 until the clamping portion 32 is arranged on the fastening extension 22. In addition, or alternatively, the clamping portion 32 can also be fastened in a form-fitting manner, for example by latching.

The second receiving section 48 is arranged between the first receiving section 46 and an edge section 50 of the shielding element 26, as shown in FIG. 3. In this case, the second receiving section 48 is positioned centrally on the side of the first receiving section 46 facing the edge section 50. This allows the edge section 50 to be positioned next to the interface opening 18 of the plug connector 10 by the clamping movement of the shielding element 26 relative to the base body 11, which inserts the fastening extension 22 into the second receiving section 48 in a clamping manner, so that complete shielding of the base body side with the shielding element 26 can be achieved. The first and second receiving sections 46, 48 are mirror-symmetrical with respect to a common axis of symmetry, the axis of symmetry being parallel to the connection axis 14.

The edge section 50 may be positioned close to the connector face (the female multipoint connector) or the front edge of the collar (the male multipoint connector) at the level of the contacting region when the shielding element is clamped to the base body of the plug connector. In this case, the edge section 50 on the female multipoint connector does not protrude beyond the interface plane of the interface opening in order to achieve a space-saving plug connector.

As shown in FIG. 3, the shielding element 26 has a tab 52, which has an arrangement section 53 that is offset from a shield base portion 54 by a bend 56. The arrangement section 53 is positioned between the edge section 50 and the bend 56. The tab 52 has the extension receptacle 28, which is formed in the arrangement section 53, the bend 56, and the shield base portion 54. In this case, the second receiving section 48 is formed completely in the arrangement section 53, while the first receiving section 46 extends from the shielding base portion 54 via the bend 56 to the arrangement section 53. In an embodiment, the shielding element 26 has a plurality of tabs 52 projecting from the same side of the shielding base portion 54 in the same direction.

The arrangement section 53 rests on the arrangement surface 20 (FIG. 2) when the shielding element 26 is attached to the base body. The tab 52 has, at most, the width of the arrangement pocket 34. In an embodiment, the arrangement section 53 is aligned parallel to the shielding base portion 54 adjacent to the bend 56. Alternatively, the arrangement section 53 may be angled with respect to the shielding base portion 54. The shielding base portion 54 is a flat sheet metal portion of the shielding element 26.

The tab 52 projects from the shielding base portion 54, wherein a section of the shielding element 26 can be arranged next to the tab 52, which has a sub-section 58 angled away from the shielding base portion 54 in accordance with the chamfer 40. The sub-section 58 and the tab 52 are cut off by a slot 59, shown in FIG. 3. In an embodiment, the shielding element 26 has a plurality of tabs 52, each of which in particular has at least one extension receptacle 28. The plurality of tabs 52 can be formed on a single side of the shielding element 26.

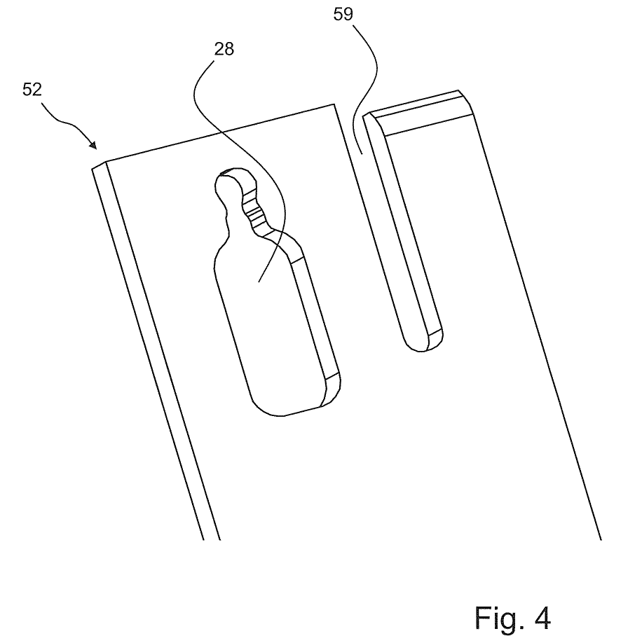

In FIG. 4, the tab 52 of the shielding element 26 is shown before it is bent or offset. The offset tab 52 with the extension receptacle 28 can be manufactured from a flat sheet by a punching and bending process. In the manufacturing process, the extension receptacle 28 is first punched out and then the bend 56 is formed.

Insertion of the fastening extension 22 into the extension receptacle 28 is further facilitated if the extension receptacle 28 is at least partially formed on the tab 52 carrying the bend 56. This creates an extension receptacle 28 that is not only formed in a plane parallel to the arrangement surface 20. The receiving contour is aligned in parts parallel and in parts perpendicularly to the arrangement surface 20.

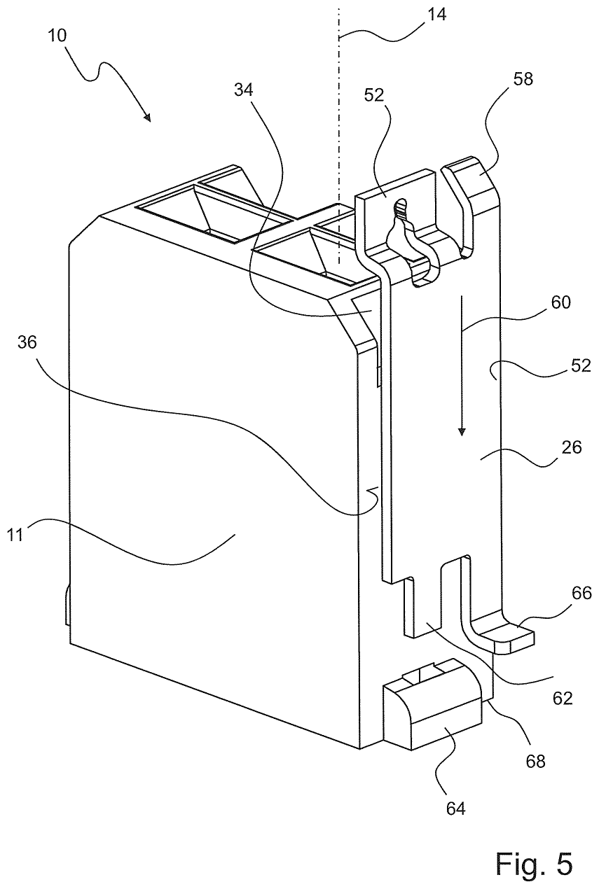

FIG. 5 shows a fastening step for fastening the shielding element 26 to the base body 11. Here, a vertical movement 60 of the shielding element 26, which is aligned parallel to the connection axis 14 and relative to the base body 11, brings the tab 52 closer to the arrangement pocket 34. At the same time, a positioning element 62, which can be located opposite the tab 52 on the shielding base portion 54, can be moved towards a positioning pocket 64 on the side surface 36. In particular, the vertical movement 60 brings a soldering extension 66 closer to a lower edge 68 of the base body 11 opposite the contacting region 12 with respect to the side surface 36 of the base body 11. The vertical movement 60 runs parallel to the connection axis 14 from the side of the contacting region 12 in the direction of the lower edge 68 of the base body 11.

The soldering extension 66 can protrude vertically from the shielding base portion 54 and can project beyond the housing lower side—visible at the edge as the lower edge 68 of the housing 11—when the shielding element 26 has reached the final mounting position. In principle, a plurality of soldering extensions 66 are provided on a shielding base portion 54, which are aligned in the same direction. In particular, the soldering extensions 66 have an L-shaped structure in the vertical sectional view, wherein the lower side of the soldering extension 66 is provided to be soldered to a circuit board not shown in the Figures.

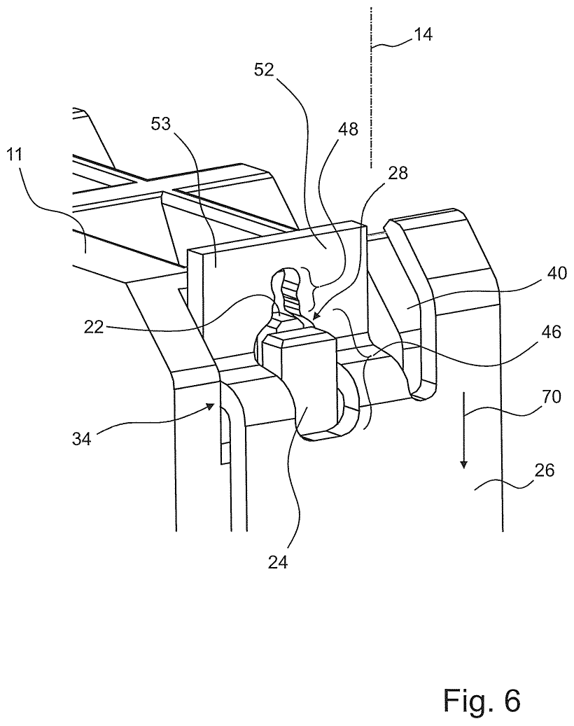

According to FIG. 6, the fastening extension 22 and the securing portion 24 are inserted into the first receiving section 46 by an insertion movement 70 of the shielding element 26 that is aligned parallel to the connection axis 14 relative to the base body 11. During the insertion of the securing portion 24 into the first receiving section 46, the shielding element 26 is aligned by the receiving contour 30 and the fastening extension 22 is centered with respect to the second receiving section 48. In an embodiment, the positioning element 62 (FIG. 5) is simultaneously aligned for insertion into the positioning receptacle 64 and finally inserted therein.

In this case, the rear side of the shielding base portion 54 of the shielding plate 26 is guided tangentially along the side surface 36 of the base body 11. The vertical movement 60 from FIG. 5 can merge seamlessly into the insertion movement 70. The vertical movement 60 is aligned with the insertion movement 70.

According to FIG. 7, as the insertion movement 70 continues, the fastening extension 22 is inserted into the second receiving section 48. The insertion movement 70 from FIG. 6 can merge seamlessly into a clamping movement 72, wherein the clamping movement 72 is aligned with the insertion movement 70.

The vertical movement 60, the clamping movement 72 and the insertion movement 70 can be carried out in a single collective movement in an embodiment.

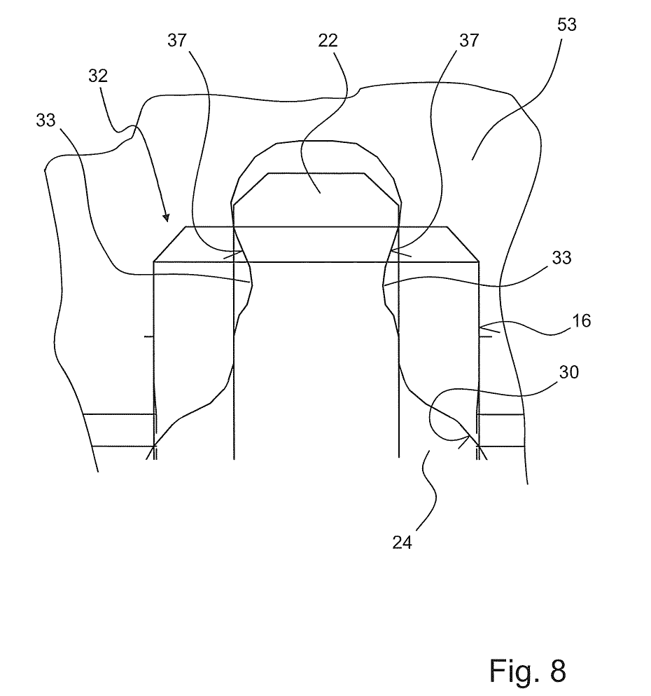

The clamping movement 72 takes place until the protrusions 33, as shown in FIG. 8, come to rest on the fastening surface 37 of the fastening extension 22 and a form-fitting and/or force-fitting fastening of the shielding element 26 is ensured. At the same time, the angled partial section 58 (FIG. 3) of the shielding element 26 can come to rest on the chamfer 40 of the base body 11 and form a kind of stop.

When the shielding element 26 is fastened to the housing 11, the edge portion 50 of the tab 52 does not protrude beyond the interface plane 12 of the interface opening 18 or the connector face.

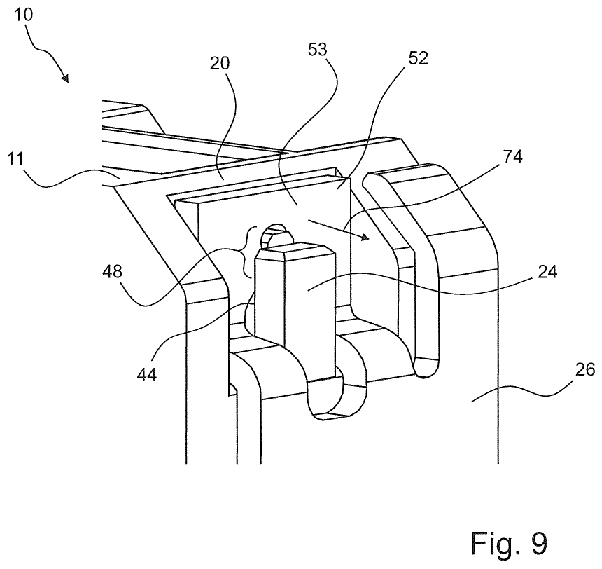

After the shielding element 26 has been clamped to the fastening extension 22, the shielding element 26 cannot be removed from the base body 11 along a direction 74 (FIG. 9) perpendicular to the arrangement plane 20 due to the securing portion 24 and the positioning extension 62 inserted into the positioning receptacle 64 (FIG. 5). In the final mounting position, the arrangement section 53 lies in the area 48 close to the edge section between the surface of the arrangement section 20 (on the housing) and the rear side of the securing portion 24 (on the housing). The receiving contour 30 of the extension receptacle 28 formed in the area of the second receiving section 48, more precisely the protrusions 33, clamps into the fastening surface 37 and lies with clearance against the securing outer edge 44 (FIG. 2).

In principle, all of the above features relating to the plug connector 10 are also applicable to mating plug connectors. The plug connector 10 in which the shielding plate fastening described above is used can be a male or a female plug connector, wherein the mating plug connector forms the counterpart that can be connected to the plug connector accordingly. In an embodiment, both the plug connector 10 and the mating plug connector can each have at least one shielding element 26, which is attached to the respective base body 11 in the same way as described above.

In other embodiments, the clamping of the protrusions 33 on the fastening surface 37 can be replaced by a device for latching the shielding element 26 to the fastening extension 22 or combined with such a device for latching.

The plug connector 10 has a shielding against electromagnetic fields, which can be manufactured in a simple and cost-effective manner and reliably mounted in a plug connector assembly.

A mounting method for fastening the shielding element 26 to the base body 11 of the plug connector 10 is part of the invention, wherein the fastening extension 22 is inserted into the extension receptacle 28 in an insertion movement of the shielding element 26 that is aligned parallel to the connection axis relative to the base body 11. In the process, the shielding element 26 is guided along the base body 11 in a movement aligned parallel to the arrangement surface 20 until the fastening extension 22 is inserted into the extension receptacle 28. This means that no complex movement sequences are required to attach the shielding element 26 to the base body 11.

A further simple method step involves the shielding element 26 being displaced relative to the fastening extension 22 in a clamping movement of the shielding element 26 that is aligned parallel to the connection axis 14 and relative to the base body 11, so that the clamping portion 32 is arranged in the extension receptacle 28 on the fastening surface 37 of the fastening extension 22. The clamping movement may be aligned in such a way that the edge section 50 of the shielding element 26 does not protrude beyond the interface plane of the interface opening or the connector face of the plug connector 10 after the clamping movement has been carried out.

What is claimed is:

1. A plug connector, comprising:
a base body having a fastening extension projecting from an arrangement surface, the arrangement surface is positioned in an arrangement pocket of the base body, the fastening extension does not protrude from the arrangement pocket; and
a shielding element having an extension receptacle fastening the shielding element to the fastening extension, the shielding element is formed of a metallic material, the extension receptacle has a receiving contour directed inwardly into the extension receptacle and a clamping portion that rests on a fastening surface of the fastening extension in a form-fitting and/or force-fitting manner when the shielding element is fastened to the fastening extension.

2. The plug connector of claim 1, further comprising a contacting region electrically and mechanically connecting to a mating plug connector aligned along a connection axis.

3. The plug connector of claim 2, wherein the arrangement surface is arranged next to the contacting region.

4. The plug connector of claim 3, wherein the arrangement surface is aligned at least in sections parallel to the connection axis.

5. The plug connector of claim 2, wherein the fastening extension is aligned transversely to the connection axis.

6. The plug connector of claim 1, wherein the fastening extension has a securing portion at a distal end, the securing portion has a securing outer edge that is offset with respect to the fastening surface.

7. The plug connector of claim 1, wherein the extension receptacle has a first receiving section and a second receiving section, the first receiving section is wider than the second receiving section.

8. The plug connector of claim 7, wherein the second receiving section is arranged between the first receiving section and an edge section of the shielding element.

9. The plug connector of claim 1, wherein the extension receptacle is at least partially formed in a tab of the shielding element.

10. The plug connector of claim 1, wherein the shielding element has a bend.

11. The plug connector of claim 10, wherein the clamping portion is formed on an arrangement section arranged between the bend and an edge section of the shielding element.

12. The plug connector of claim 11, wherein the extension receptacle is formed at least partially on the bend.

13. The plug connector of claim 11, wherein the arrangement section is parallel to a shielding base portion adjacent to the bend.

14. The plug connector of claim 1, wherein the receiving contour surrounds the extension receptacle in a closed manner.

15. The plug connector of claim 1, wherein the clamping portion has a protrusion on the receiving contour.

16. The plug connector of claim 15, wherein the protrusion latches and/or clamps to the shielding element.

17. A method for fastening a plug connector, comprising:
providing a base body having a fastening extension projecting from an arrangement surface, the arrangement surface is positioned in an arrangement pocket of the base body, the fastening extension does not protrude from the arrangement pocket;
providing a shielding element having an extension receptacle, the shielding element is formed of a metallic material, the extension receptacle has a receiving contour directed inwardly into the extension receptacle and a clamping portion;
inserting the fastening extension into the extension receptacle in an insertion movement of the shielding element relative to the base body, the clamping portion rests on a fastening surface of the fastening extension in a form-fitting and/or force-fitting manner when the shielding element is fastened to the fastening extension.

18. The method of claim 17, wherein the plug connector has a contacting region electrically and mechanically connecting to a mating plug connector aligned along a connection axis, the insertion movement is parallel to the connection axis.

19. The method of claim 17, wherein the shielding element is offset relative to the fastening extension in a clamping movement of the shielding element.
